(19) United States
(12) Patent Application Publication
(10) Pub. No.: US 2021/0115340 A1
(43) Pub. Date: Apr. 22, 2021

(54) PROCESSES AND APPARATUSES FOR UPGRADING LIGHT HYDROCARBONS

(71) Applicant: ExxonMobil Research and Engineering Company, Annandale, NJ (US)

(72) Inventors: Mohsen N. Harandi, New Hope, PA (US); Yira Y. Aponte, Sarnia (CA)

(21) Appl. No.: 16/997,009

(22) Filed: Aug. 19, 2020

Related U.S. Application Data
(60) Provisional application No. 62/916,266, filed on Oct. 17, 2019.

(51) Int. Cl. C10G 11/05; B01J 8/18; B01J 29/40; C10G 69/04; B01D 3/14; B01D 3/00; B01D 3/06

(52) U.S. Cl. CPC C10G 11/05; B01J 8/1827; B01J 8/1836; B01J 29/40; C10G 69/04; B01D 3/143; B01J 2208/00752; B01D 3/06; C10G 2300/301; C10G 2400/02; C10G 2300/202; C10G 2300/4018; B01D 3/009

(57) ABSTRACT

The present disclosure provides processes for converting a hydrocarbon feedstock to a hydrocarbon product stream. A process may include introducing the hydrocarbon feedstock to a reactor including a catalyst to form a reactor effluent having a temperature of from about 700° F. to about 1300° F. The catalyst may include a crystalline microporous material. The process may also include cooling the reactor effluent to a temperature of from about 350° F. to about 550° F. to form a condensate and a vapor stream. The condensate and vapor stream may be separated in a first separation system. Additionally, the vapor stream may be introduced to a second separation system to form a hydrocarbon product stream and a light hydrocarbon stream. The present disclosure also relates to apparatuses including a reactor, a vapor-liquid separator, a heat exchanger, and a separation system.

### CROSS-REFERENCE TO RELATED APPLICATIONS

This application claims the benefit of priority from U.S. Provisional Application No. 62/916,266 filed Oct. 17, 2019, which is herein incorporated by reference in its entirety.

### FIELD OF THE INVENTION

The present disclosure relates to processes and apparatuses for the upgrading of light hydrocarbons and production and purification of gasoline and diesel range hydrocarbons.

### BACKGROUND OF THE INVENTION

The upgrading of hydrocarbons, such as low molecular weight hydrocarbons, to value improved gasoline and diesel range hydrocarbons has long been a focus of researchers. The conversion of light hydrocarbons to gasoline and diesel range hydrocarbons has been accomplished in fixed bed reactors with zeolite catalysts. The product mixture typically includes unreacted light hydrocarbons, the desired products, and heavy hydrocarbons outside of the desired product range. The purification of the desired products (gasoline and diesel range hydrocarbons) has been accomplished using distillation, but distillation at sufficient temperature is energy intensive and costly.

Historically light hydrocarbon feedstocks have come from refinery process streams (including light cuts, and steam cracked refinery feeds). The feedstocks may contain sulfur containing compounds, including sulfur containing light hydrocarbons. The sulfur containing compounds may be included in the conversion of light hydrocarbons to higher hydrocarbons and increase in molecular weight. The higher molecular weight sulfur containing compounds might be difficult to remove without hydrotreatment. Additionally, certain low levels of sulfur should be achieved if the hydrocarbons are to be sold or blended into gasoline and diesel fuels.

Additionally, the conversion of light hydrocarbons to gasoline and diesel range hydrocarbons may produce heavy hydrocarbons including a heavy hydrocarbon tail not suitable for blending with gasoline or diesel range hydrocarbon to be used as fuel. Separation of the hydrocarbons too heavy to be suitable for blending may include costly distillations.

There is a need for improved upgrading processes to produce high value low-sulfur gasoline that are more energy efficient and less costly. Additionally, there is a need for low cost separation of heavier hydrocarbons that is simple and efficient.

### SUMMARY OF THE INVENTION

The present disclosure relates to processes for converting a hydrocarbon feedstock to a hydrocarbon product stream. A process may include introducing the hydrocarbon feedstock to a reactor including a catalyst to form a reactor effluent having a temperature of from about 700° F. to about 1300° F. The catalyst may include a crystalline microporous material. The process may also include cooling the reactor effluent to a temperature of from about 350° F. to about 550° F. to form a condensate and a vapor stream. The condensate and vapor stream may be separated in a first separation system. Additionally, the vapor stream may be introduced to a second separation system to form a hydrocarbon product stream and a light hydrocarbon stream.

The present disclosure also relates to additional processes for converting a hydrocarbon feedstock to a hydrocarbon product stream. A process may include introducing the hydrocarbon feedstock to a reactor including a catalyst to form a reactor effluent having a temperature of from about 700° F. to about 1300° F. The catalyst may include a crystalline microporous material. The process may also include cooling the reactor effluent to a temperature of from about 350° F. to about 550° F. to form a condensate and a vapor stream. The condensate and vapor stream may be separated in a first separation system where the condensate includes 50 wt % of distillate boiling components and where the condensate is about 3 wt % to about 30 wt % of the reactor effluent. Additionally, the vapor stream may be introduced to a second separation system to form a hydrocarbon product stream and a light hydrocarbon stream.

The present disclosure also relates to apparatuses including a reactor, a vapor-liquid separator, a heat exchanger, and a separation system.

### BRIEF DESCRIPTION OF THE DRAWINGS

So that the manner in which the above recited features of the disclosure can be understood in detail, a more particular description of the disclosure, briefly summarized above, may be had by reference to implementations, some of which are illustrated in the appended drawings. It is to be noted, however, that the appended drawings illustrate only typical implementations of this disclosure and are therefore not to be considered limiting of scope, for the disclosure may admit to other equally effective implementations.

FIG. 1 is a flow diagram illustrating light hydrocarbon upgrading with a vapor-liquid separation device, according to an embodiment.

FIG. 2 is a flow diagram illustrating light hydrocarbon upgrading with a vapor-liquid separation device, according to an embodiment.

FIG. 3 is a flow diagram illustrating light hydrocarbon upgrading with a vapor-liquid separation device, according to an embodiment.

To facilitate understanding, identical reference numerals have been used, where possible, to designate identical elements that are common to the Drawings. It is contemplated that elements and features of one implementation may be beneficially incorporated in other implementations without further recitation.

### DETAILED DESCRIPTION OF THE INVENTION

It has been discovered that separation of the heavy hydrocarbon tail of the reactor effluent via vapor-liquid separation can increase the efficiency of processes for the upgrading of light hydrocarbons to gasoline and diesel range hydrocarbons. This separation provides a low-cost, simple, and efficient way to reduce the heavy hydrocarbons and produce a product more suitable for blending in fuel streams. Additionally, it has been discovered that separation of the heavy hydrocarbon tail from the reactor effluent may also remove sulfur containing compounds from the product mixture and therefore decrease additional processing before the products may be blended into gasoline or sold as fuel.

The present disclosure relates to processes for the removal of high boiling hydrocarbon including sulfur-containing compounds from a hydrocarbon product stream as part of processes to produce gasoline and diesel range hydrocarbons from light hydrocarbons. The product of upgrading reactions may contain contaminants that might affect downstream processing and/or the value of the produced hydrocarbons. The management of such contaminants allows for more cost effective processing of hydrocarbon product mixtures within the scope of refining processes and within the ranges mandated by regulatory authorities.

In at least one embodiment, the present disclosure provides a process for producing higher molecular weight hydrocarbons from a hydrocarbon feed containing light hydrocarbons including sulfur-containing compounds. The process includes introducing a light hydrocarbon feed to a reactor to produce a reactor effluent. The process includes cooling the reactor effluent to form a condensate and a vapor stream. The process includes separating the condensate from the vapor stream in a first separation system, the vapor stream having substantially fewer sulfur-containing compounds than the reactor effluent. The process includes introducing the vapor stream to a second separation system to form a hydrocarbon product stream.

### Definitions

The term “sulfur concentration” means the wt % of sulfur atoms within a stream based on the total weight of the stream in which the sulfur concentration is measured. Concentrations of a sulfur containing molecule are stated as the concentration of that molecule (e.g. methyl mercaptan concentration), and are based on the wt % of sulfur containing molecules based on the total weight of the stream in which the sulfur containing molecules are measured, unless otherwise indicated.

The term “Cn” hydrocarbon means hydrocarbon having n carbon atom(s) per molecule, where n is a positive integer. The term “Cn+” hydrocarbon means hydrocarbon having at least n carbon atom(s) per molecule, where n is a positive integer. The term “Cn−” hydrocarbon means hydrocarbon having no more than n number of carbon atom(s) per molecule, where n is a positive integer. The term “hydrocarbon” means a class of compounds containing hydrogen bound to carbon, and encompasses (i) saturated hydrocarbon, (ii) unsaturated hydrocarbon, and (iii) mixtures of hydrocarbons, including mixtures of hydrocarbon compounds (saturated and/or unsaturated), including mixtures of hydrocarbon compounds having different values of n. A mixture of Cn Cm hydrocarbon, where m and n are integers and n<m, means a mixture containing at least Cn and Cm hydrocarbon and optionally one or more hydrocarbon compounds having a number of carbon atoms greater than n but less than m.

The term “unsaturate” or “unsaturated hydrocarbon” mean a C2+ hydrocarbon containing at least one carbon atom directly bound to another carbon atom by a double or triple bond. The term “olefin” means an unsaturated hydrocarbon containing at least one carbon atom directly bound to another carbon atom by a double bond. In other words, an olefin is a compound which contains at least one pair of carbon atoms, where the pair is directly linked by a double bond.

The term “T90” means the temperature, determined according to the boiling point distribution described above, at which 90 weight percent of a particular hydrocarbon sample has reached its boiling point. Likewise, “T10”, “T50”, “T95”, and “T98” mean the temperature at which 10, 50, 95, or 98 weight percent of a particular sample has reached its boiling point. Nominal final boiling point means the temperature at which 99.5 weight percent of a particular sample has reached its boiling point. Nominal initial boiling point means the temperature at which 0.5 weight percent of a particular sample has reached its boiling point.

The term “light hydrocarbon(s)” means C4− hydrocarbons.

The term “gasoline range hydrocarbons” means a mixture of hydrocarbons having a nominal initial boiling point of about 95° F. (35° C.) or greater to a T90 of about 427° F. (220° C.) or less.

The term “distillate range hydrocarbon(s)” means a mixture of hydrocarbons with a T10 of about 300° F. (149° C.) or greater to a T90 of about 750° F. (399° C.) or less.

### Hydrocarbon Feed

The hydrocarbon feed (e.g., of line 101 of FIGS. 1-3) may include relatively low molecular weight hydrocarbons, such as C1 to C7 hydrocarbons, including olefins and/or paraffins. The hydrocarbon feed typically includes C5− hydrocarbon, which may include one or more of butane, isobutane, 1-butene, 2-butene, 1,3-butadiene, propane, propene, ethane, ethylene, methane, or other suitable light hydrocarbons. In some embodiments, carbon monoxide and/or syngas are also fed to the reactor either separately or in conjunction with the hydrocarbon feed. It may be advantageous to use a hydrocarbon feedstock including economically advantaged, minimally processed light hydrocarbon streams containing a C5− hydrocarbon mixture from refinery processes. The hydrocarbon feed can have a nominal final boiling point of about 120° F. (49° C.) or less, such as about 110° F. (43° C.) or less, about 100° F. (38° C.) or less, or about 95° F. (35° C.) or less.

The hydrocarbon feed may include relatively high molecular weight hydrocarbon (heavy hydrocarbon). The relative amounts of light hydrocarbon (typically in the vapor phase) and heavy hydrocarbon (typically in the liquid phase and naphtha boiling range) in the hydrocarbon feed can be from 100 wt % light hydrocarbon to about 90 wt % light hydrocarbon. For example, the hydrocarbon feed can include about 0.01 wt % or less of heavy hydrocarbon, based on the weight of the hydrocarbon feed, such as about 10 wt % or less, about 5 wt % or less, about 2 wt % or less, about 1 wt % or less, about 0.5 wt % or less, about 0.1 wt % or less, or about 0.01 wt % or less. Alternatively the feed can be composed of 100% or less naphtha boiling range molecules

The hydrocarbon feed may also include one or more contaminants including one or more sulfur compounds, such as inorganic sulfur compounds and/or organic sulfur compounds. The sulfur compounds may include hydrogen sulfide (H2S), Methyl Mercaptan (MM), Ethyl Mercaptan (EM), Carbonyl Sulfide (COS), Carbon Disulfide (CS2), Dimethyl Sulfide (DMS), one or more C3+ mercaptans, one or more thiophenes, or combination(s) thereof.

The hydrocarbon feed has a sulfur concentration (also referred to as a “first sulfur concentration”) measured according to ASTM D5453. The first sulfur can be about 9000 ppm or less, for example, the first sulfur concentration may be from about 10 ppm to about 1000 ppm, from about 100 ppm to about 1000 ppm, from about 200 ppm to about 500 ppm, or from about 250 ppm to about 300 ppm.

### Reactor

The conversion reaction can be conducted in a reactor, which can be any suitable reactor system including, a fixed bed reactor, a moving bed reactor, a fluidized bed reactor, and/or a reactive distillation unit. In addition, the reactor may include a single reactor or multiple reactors connected in series or in parallel. A reactor may include a bed of catalyst particles where the particles have insignificant motion in relation to the bed (a fixed bed) or a bed of catalyst particles where at least a majority of catalyst particle remain in motion during the course of a reaction (a fluidized bed). In addition, injection of the hydrocarbon feed can be effected at a single point in the reactor or at multiple points spaced along the reactor.

In certain embodiments, the reactor includes a single bed or a plurality of beds, continuous flow-type reactors in either a down flow or up flow mode, where the reactors may be arranged in series or parallel. The reactor may include single or multiple catalyst beds in series and/or in parallel. The catalyst beds may have various configurations such as: a single bed, several horizontal beds, several parallel packed tubes, multiple beds each in its own reactor shell, or multiple beds within a single reactor shell. In certain embodiments, the reactor includes fixed beds which provide uniform flow distribution over the entire width and length of the bed to utilize substantially all of the catalyst. In at least one embodiment, the reactor can provide heat transfer from a fixed bed to provide effective methods for controlling temperature.

The efficiency of a reactor containing a fixed bed of catalyst might be affected by the pressure drop across the fixed bed. The pressure drop depends on various factors such as the path length, the catalyst particle size, and pore size. A pressure drop that is too large may cause channeling through the catalyst bed, and poor efficiency. In some embodiments, the reactor has a cylindrical geometry with axial flows through the catalyst bed.

In a fluidized bed reactor, baffles may be added to the reactor vessel to control radial and axial mixing. One or more cyclone separators may be included to separate entrained catalyst fines from the reactor effluent. The cyclone separators may be positioned in an upper portion of the reactor vessel including dispersed catalyst phase. Filters, such as sintered metal plate filters, can be used alone or in conjunction with cyclone separators.

The various designs of the reactor may accommodate control of specific process conditions, e.g. pressure, temperature, and WHSV. The WHSV determines volume and residence time that provide desired conversion.

An advantage of using a fluidized bed process is close temperature control, where the uniformity of conversion temperature can be maintained within close tolerances, often less than 25° C. (75° F.). Except for a small zone adjacent the bottom gas inlet, the midpoint measurement is representative of the entire bed, due to the thorough mixing achieved.

### Reactor Conditions

In a typical process, the hydrocarbon feed is converted in a catalytic reactor at a temperature from about 600° F. to about 1200° F. (about 260° C. to about 650° C.) and moderate pressure from about 100 psig to about 400 psig (about 790 kPa to about 3200 kPa) to produce a predominantly liquid product including C5+ aliphatic hydrocarbons rich in gasoline-range saturates, olefins and C6 to C11 alkyl aromatic hydrocarbons. A typical reactor unit employs a temperature-controlled catalyst zone with indirect heat exchange and/or adjustable gas quench. The reaction temperature can be in part controlled by exchanging hot reactor effluent with hydrocarbon feed and/or recycle streams. Optional heat exchangers may recover heat from the effluent stream prior to separation. Part or all of the reaction heat can be removed from the reactor by using cold feed, whereby reactor temperature can be controlled by adjusting feed temperature. The reaction temperature may be controlled within an operating range from about 600° F. to about 1200° F. (about 260° C. to about 650° C.). The reactor may be operated at a pressure from about 50 psig to about 500 psig (about 445 kPa to about 3550 kPa), such as about 100 psig to about 250 psig (about 790 kPa to about 1825 kPa).

A fluidized bed may have a superficial vapor velocity from about 0.1 to 2 meters per second (m/sec). A convenient measure of fluidization in a fluidized bed is the bed density. A typical fluidized bed has an operating density from about 100 kg/m3 to about 500 kg/m3, such as about 300 kg/m3 to about 500 kg/m3, measured at the bottom of the reaction zone, becoming less dense toward the top of the reaction zone, due to pressure drop and particle size differentiation. A pressure differential between two vertically spaced points in the reactor column can be measured to obtain the average bed density at such portion of the reaction zone. For instance, in a fluidized bed system employing zeolite particles having an apparent packed density of about 750 kg/m3 and real density of about 2430 kg/m3, an average fluidized bed density of about 300 kg/m3 to about 500 kg/m3 is typical.

The reactor process conditions, including temperature and pressure, may be controlled to reduce cracking of C3 to C6 paraffin hydrocarbons in the feed. The weight hourly space velocity and uniform contact may provide control of contact time of vapor or vapor and liquid and solid phases. The hydrocarbon feed may have a WHSV from about 0.01 h-1 to about 10 h-1, such as about 0.1 h-1 to about 5 h-1.

Several parameters contribute to fluidization in a reactor including the use of a catalyst support with a solid density (weight of a representative individual particle divided by its apparent “outside” volume) of from about 0.6 g/cc to about 2 g/cc, such as from about 0.9 g/cc to about 1.6 g/cc. At higher pressures, a lower gas velocity may be employed to ensure operation in the turbulent fluidization regime.

### Catalyst

Catalyst particles may vary in particle size and include particle of about 250 microns or less, with an average particle size from about 10 microns to about 150 microns, such as from about 20 microns to about 100 microns, or from about 40 microns to about 80 microns.

The catalyst may include crystalline microporous materials including medium pore siliceous materials having similar pore geometry, such as zeolites of the ZSM-5 class. ZSM-5 zeolites are typically synthesized with Brønsted acid active sites by incorporating a tetrahedrally coordinated metal, such as Al, Ga, B or Fe, within the zeolitic framework. These medium pore zeolites may be used for acid catalysis; however, the advantages of ZSM-5 structures may be utilized by employing highly siliceous materials or crystalline metallosilicate having one or more tetrahedral species having varying degrees of acidity. ZSM-5 crystalline structure is readily recognized by its X-ray diffraction pattern, which is described in U.S. Pat. No. 3,702,866 (Argauer, et al.), incorporated by reference.

The catalyst may include the medium pore (e.g., about 5-7 A) shape-selective crystalline microporous materials including zeolites. The catalysts may have a silica-to-alumina ratio of about 12 or more, such as about 12 to about 50, or about 15 to about 30. The catalysts may have a constraint index of about 1 to about 12, such as about 2 to about 10, about 3 to about 8, or about 4 to about 7. Furthermore, catalysts may have significant Brønsted acid activity. In the reactor the catalyst may have an acid activity (alpha value) of about 0.1 to 200 under steady state process conditions, such as about 1 to about 180, about 5 to about 160, or about 10 to about 150. ZSM-5 type zeolites include ZSM-5, ZSM-11, ZSM-12, ZSM-22, ZSM-23, and ZSM-35. ZSM-5 is disclosed in U.S. Pat. No. 3,702,886 and U.S. Pat. No. Re. 29,948, incorporated by reference. Other suitable zeolites are disclosed in U.S. Pat. Nos. 3,709,979; 3,832,449; 4,076,979; 3,832,449; 4,076,842; 4,016,245 and 4,046,839; 4,414,423; 4,417,086; 4,517,396 and 4,542,251, all incorporated by reference. Zeolites having a coordinated metal oxide to silica molar ratio of about 20:1 to about 200:1 may be used. It may be advantageous to employ a ZSM-5 having a silica alumina molar ratio of about 25:1 to 70:1, suitably modified with optional support or optional binder. A zeolite catalyst having Brønsted acid sites may include a crystalline microporous material, such as an aluminosilicate having the structure of ZSM-5 zeolite with 5 to 95 wt. % silica, clay and/or alumina binder.

Zeolite catalysts may be employed in their acid form, ion exchanged or impregnated with one or more suitable metals, such as Ga, Pd, Zn, Ni, Co and/or other metals of Periodic Groups 3 to 10. In some embodiments, the catalyst is HSM-5, the hydrogen form of ZSM-5, produced by ion exchange with a suitable proton donor, such as ammonium nitrate. In some embodiments, the catalyst is Ni-exchanged or impregnated and may be useful in converting olefins under mild conditions. The zeolite may include other components, typically one or more metals of groups 11 to 17 of the Periodic Table of the Elements. In some embodiments, the catalyst is a phosphorus modified ZSM-5. Phosphorus modification of zeolites may be accomplished by any suitable method, such incipient wetness impregnation or hydrothermal dispersion or phosphorus. Useful hydrogenation components include the noble metals of Group 8, especially platinum, but other noble metals, such as palladium, gold, silver, rhenium or rhodium, may also be used. Base metal hydrogenation components may also be used, especially nickel, cobalt, molybdenum, tungsten, copper or zinc. The catalyst materials may include two or more catalytic components, such as a metallic oligomerization component (e.g., ionic Ni+2, and a shape-selective medium pore acidic oligomerization catalyst, such as ZSM-5 zeolite) which components may be present in admixture or combined in a unitary bifunctional solid particle. It is possible to utilize an olefin dimerization metal or oligomerization agent to effectively convert hydrocarbon feed including olefins in a continuous reaction zone. Certain of the ZSM-5 type medium pore shape selective catalysts are sometimes known as pentasils. In addition to aluminosilicates, the borosilicate, ferrosilicate and “silicalite” materials may be employed. ZSM-5 type pentasil zeolites may have a crystal size from about 0.01 to about 4 microns, such as about 0.02 microns to about 1 micron.

In some embodiments, fluidized bed catalyst particles include 25 or 40 wt % H-ZSM-5 catalyst contained within a silica-alumina matrix and having a fresh alpha value of about 100 or less, based on total catalyst weight. In some embodiments, the catalyst includes a 70:1 aluminosilicate H-ZSM-5 extrudate having an acid value of at least 5, such as about 150 or more.

### Heat Exchanger

The reactor effluent may pass through one or more heat exchangers which may provide sufficient cooling that a portion of the reactor effluent condenses into a liquid. The portion that condenses to a liquid can be a condensate, and the portion that remains in the gaseous phase can be a vapor stream. The heat exchanger allows for cooling of the reactor effluent to a temperature from about 350° F. to about 550° F. (about 177° C. to about 288° C.), such as about 375° F. to about 525° F. (about 190° C. to about 274° C.), about 400° F. to about 500° F. (about 204° C. to about 260° C.), or about 400° F. to about 450° F. (about 204° C. to about 232° C.). The heat exchanger may be any suitable heat exchanger, such as a shell-and-tube exchanger, spiral wound, airfin, double-pipe, a plate and frame, a plate and shell, a plate fin, a microchannel, or another indirect or direct contact heat exchanger.

### First Separation System

The reactor may be coupled with a heat exchanger coupled with a first separation system, which includes at least one flash separation vessel, which is a vapor/liquid separation device (sometimes referred to as flash pot or flash drum), which can provide separation of the reactor effluent into a vapor stream and a condensate. A flash separation vessel may be used when the reactor effluent includes about 1 wt % or more of C10+ hydrocarbons based on the weight of the hydrocarbon components of the reactor effluent, e.g., about 10 wt % or more. Separating the reactor effluent through vapor/liquid separation may be accomplished through flash separation vessels or other suitable means, such as a stripper. Examples of suitable flash separation vessels include those disclosed in U.S. Pat. Nos. 6,632,351; 7,138,047; 7,090,765; 7,097,758; 7,820,035; 7,311,746; 7,220,887; 7,244,871; 7,235,705; 7,247,765; 7,351,872; 7,297,833; 7,488,459; 7,312,371; and 7,578,929; and, which are incorporated by reference herein.

After cooling in the heat exchanger the majority of the reactor effluent is in the vapor phase and a minor portion is condensed into the liquid phase (the condensate). The reactor effluent is transferred to and flashed in at least one flash separation vessel in order to separate the liquid phase and the vapor phase and at least a portion of the sulfur compounds and high molecular-weight molecules remain in the liquid phase. A bottoms fraction, from the liquid phase, can be removed from the flash separation vessel as a condensate including a substantial portion of the sulfur compounds. The condensate may include, for example, about 50 wt % or more of the sulfur content of the reactor effluent, and about 50 wt % or more of the heavy hydrocarbons of the reactor effluent. The condensate may include about 20 wt % or more, such as 50 wt % or more, about 70 wt % or more, about 80 wt % or more, about 90 wt % or more, about 95 wt % or more, about 98 wt % or more, or about 99 wt % or more of the sulfur content of the reactor effluent. The condensate may include about 50 wt % or more, such as 60 wt % or more, about 70 wt % or more, about 80 wt % or more, about 90 wt % or more, about 95 wt % or more, about 98 wt % or more, or about 99 wt % or more of the heavy hydrocarbons of the reactor effluent. The vapor stream, from the overhead can be conducted through another heat exchanger to a second separation system. The condensate may have a T10 boiling point of about 350° F. (about 177° C.) or more, such as 375° F. (about 190° C.) or more, 400° F. (about 204° C.) or more, 425° F. (about 218° C.) or more, or 427° F. (about 219° C.) or more.

The flash separation vessel may operate at a temperature from about 300° F. (about 150° C.) to about 600° F. (about 315° C.) and/or a pressure from about 275 kPa to about 7000 kPa.

Typically, a vapor phase is separated from the reactor effluent in the flash separation vessel forming a vapor stream. The vapor stream is conducted away from the flash separation vessel to an additional (but optional) heat exchanger and then to a second separation system. In one or more embodiments, the vapor stream has a sulfur concentration (also referred to as a “second sulfur concentration”) measured according to ASTM D5453, which is less than the first sulfur concentration of the hydrocarbon feed. The second sulfur concentration of the vapor stream may be about 1 wt %, about 3 wt %, about 5 wt %, about 10 wt %, about 15 wt %, about 20 wt %, about 25 wt %, about 30 wt %, about 35 wt %, about 40 wt %, or about 50 wt % to about 30 wt %, about 35 wt %, about 40 wt %, about 45 wt %, about 50 wt %, about 55 wt %, or about 60 wt % of the first sulfur concentration of the hydrocarbon feed. For example, the second sulfur concentration of the vapor stream can be about 1 wt % to about 60 wt %, about 3 wt % to about 60 wt %, about 3 wt % to about 50 wt %, about 5 wt % to about 45 wt %, about 5 wt % to about 40 wt %, about 10 wt % to about 35 wt %, or about 10 wt % to about 30 wt % of the first sulfur concentration of the hydrocarbon feed. The amount of sulfur compounds removed via line 113 will depend on the initial concentrations of individual sulfur compounds of the hydrocarbon feed of line 101 and the reaction conditions.

In some embodiments, the second sulfur concentration of the vapor stream is about 1 weight parts per million (wppm) to about 3000 wppm. The second sulfur concentration of the vapor stream can be about 3000 ppm or less, for example the second sulfur concentration may be from about 1 wppm to about 3000 wppm, such as about 10 wppm to about 1000 wppm, or about 10 wppm to about 500 wppm. The sulfur compounds of the vapor stream may include H2S, MM, EM, COS, CS2, or C2+ mercaptans and thiophenes. In some embodiments, the majority of organic sulfur is bound as C2+ mercaptans and thiophenes, such as about 50 wt % or greater C2+ mercaptans and thiophenes, about 60 wt % or greater, about 70 wt % or greater, about 80 wt % or greater, about 90 wt % or greater, or about 99 wt % or greater, based on the total weight of sulfur compounds of the vapor stream. The combined concentration of C2+ mercaptans and thiophenes in the vapor stream may be from about 1 wppm to about 50 wppm, or from about 10 wppm to about 1000 wppm. In some embodiments the molar ratio of C2+ sulfur compounds to C1− sulfur compounds in the vapor stream is about 2:1 or greater, about 100:1 or greater, about 1000:1 or greater, or about 10,000:1 or greater.

### Second Separation System

The upgrading process produces higher molecular weight hydrocarbons. The reactor effluent includes a combination of higher value gasoline range hydrocarbons, distillate range hydrocarbons and light hydrocarbons. The first separation system separates condensate including distillate range hydrocarbons from a vapor stream. The second separation system may be any suitable system for separation of gasoline range hydrocarbons from light hydrocarbons, such as a vapor-liquid separator, a condenser, a distillation column, or a debutanizer. Suitable separation systems are described in U.S. Pat. Nos. 4,456,779 and 4,504,693, incorporated by reference.

After passage through the first separation system and an optional second heat exchanger(s), the cooled vapor stream may be fed to a second separation system, where the gasoline range hydrocarbons are separated from the light hydrocarbons (C4− hydrocarbons). The temperature of the cooled vapor stream entering the second separation system may be at a sufficiently low temperature that the gasoline range hydrocarbons condense and separate from remaining vapor phase light hydrocarbons. Gasoline range hydrocarbons separate rapidly at temperatures of about 350° F. (about 177° C.) or less, such as from about 40° F. to about 350° F. (about 4° C. to about 177° C.), or from about 70° F. to about 100° F. (about 21° C. to about 38° C.).

The second separation system may be a distillation tower containing plates or stages and equipped with a reboiler and a condensor. The gasoline range hydrocarbons separated in the second separation system typically have an initial boiling point ranging from about 95° F. to about 150° F. (about 35° C. to about 66° C.), typically, about 100° F. (about 38° C.) or greater. In some embodiments, the distillation system is a debutanizer.

The hydrocarbon product stream has a sulfur concentration (referred to as a “third sulfur concentration”) measured according to ASTM D5453 that can be about 1 ppm to about 3000 ppm, or about 10 ppm to 100 ppm. For example, the third sulfur concentration of the light hydrocarbon stream can be from about 0.5 wt % to about 20 wt %, about 1 wt % to about 20 wt %, about 1 wt % to about 18 wt %, about 1 wt % to about 15 wt %, about 1 wt % to about 12 wt %, about 1 wt % to about 10 wt %, about 1 wt % to about 8 wt %, about 1 wt % to about 5 wt %, about 1 wt % to about 3 wt %, alternatively from about 5 wt % to about 20 wt %, about 5 wt % to about 15 wt %, about 5 wt % to about 12 wt %, about 5 wt % to about 10 wt %, about 5 wt % to about 8 wt %, about 10 wt % to about 20 wt %, about 10 wt % to about 18 wt %, about 10 wt % to about 15 wt %, or about 10 wt % to about 12 wt % of the second sulfur concentration of the vapor stream. The third sulfur concentration of the hydrocarbon product stream can be about 3000 ppm or less, or about 1000 wppm or less, for example the third sulfur concentration may be from about 10 ppm to about 100 ppm. The hydrocarbon product stream may have a T90 boiling point of about 500° F. (260° C.) or less, such as about 475° F. (246° C.) or less, 450° F. (232° C.) or less, or 427° F. (219° C.) or less.

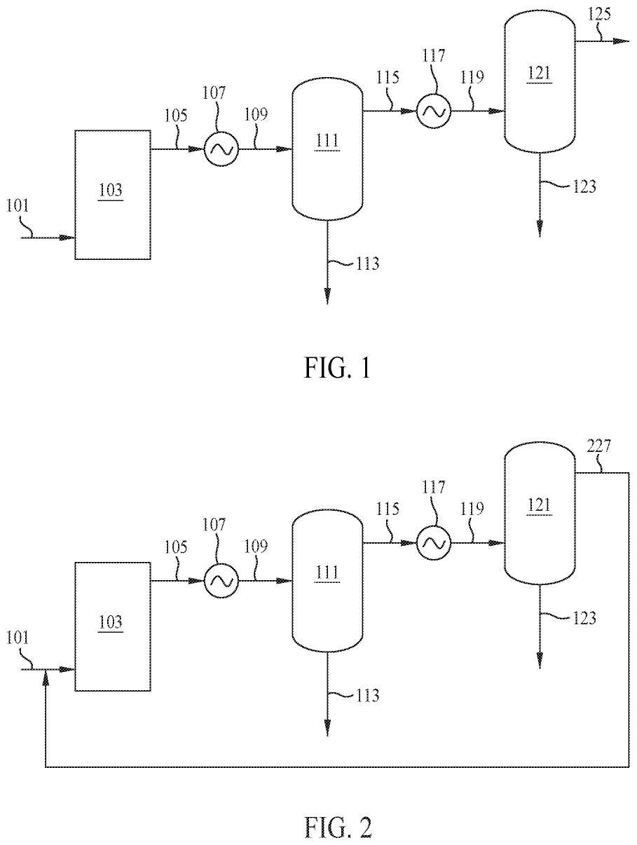

The overheads of the second separation system are removed as a light hydrocarbon stream that may be sent to other refinery processes or, as shown in FIG. 2, recycled to the reactor for further upgrading.

The light hydrocarbon stream may contain all the H2S from the reaction which may be removed by amine treatment. The light hydrocarbon stream has a sulfur concentration (referred to as a “fourth sulfur concentration”) measured according to ASTM D5453 that can be about 0.5 wt %, about 1 wt %, about 2 wt %, about 3 wt %, about 5 wt %, about 6 wt %, about 8 wt %, or about 10 wt % to about 12 wt %, about 15 wt %, about 18 wt %, or about 20 wt % of the second sulfur concentration of the vapor stream. For example, the fourth sulfur concentration of the light hydrocarbon stream can be about 0.5 wt % to about 20 wt %, about 1 wt % to about 20 wt %, about 1 wt % to about 18 wt %, about 1 wt % to about 15 wt %, about 1 wt % to about 12 wt %, about 1 wt % to about 10 wt %, about 1 wt % to about 8 wt %, about 1 wt % to about 5 wt %, about 1 wt % to about 3 wt %, about 5 wt % to about 20 wt %, about 5 wt % to about 15 wt %, about 5 wt % to about 12 wt %, about 5 wt % to about 10 wt %, about 5 wt % to about 8 wt %, about 10 wt % to about 20 wt %, about 10 wt % to about 18 wt %, about 10 wt % to about 15 wt %, or about 10 wt % to about 12 wt % of the second sulfur concentration of the vapor stream. The fourth sulfur concentration of the light hydrocarbon stream can be about 100 wppm or less, for example the fourth sulfur concentration may be from about 0.01 ppm to about 100 ppm, from about 0.1 ppm to about 80 ppm, or from about 1 ppm to about 50 ppm. The light hydrocarbon stream may have a T90 boiling point of about 150° F. (66° C.) or less, such as about 140° F. (60° C.) or less, 130° F. (54° C.) or less, or 120° F. (49° C.) or less.

### Hydrotreating

The condensate from the first separation system may be further processed in a hydrotreater. The hydrotreater may include hydroprocessing in which condensate, treat gas including hydrogen, and catalyst are combined under hydroprocessing conditions to produce a distillate range hydrocarbon product (“hydrotreated condensate”) having improved blending characteristics with other heavy hydrocarbons such as fuel oil. The hydrotreater may further remove sulfur and other impurities to provide a hydrotreated condensate that is compatible with fuel oils. In some embodiments, the condensate is routed as a reflux to the FCC or coker main fractionator and recovered as a light cycle oil with FCC or coker product and treated in the associated hydrotreater in a conventional manner.

The hydroprocessing is carried out in the presence of hydrogen by (i) combining molecular hydrogen with the condensate upstream of the hydroprocessing and/or (ii) conducting molecular hydrogen to the hydrotreater in one or more conduits or lines. Although relatively pure molecular hydrogen can be utilized for the hydroprocessing, for reduced cost it may be desirable to utilize a “treat gas” which contains sufficient molecular hydrogen for the hydroprocessing and optionally other species (e.g., nitrogen and light hydrocarbons such as methane) which typically do not adversely interfere with or affect either the reactions or the products. The treat gas may contain about 50 vol % or greater of molecular hydrogen, such as about 75 vol % or greater, based on the total volume of treat gas conducted to the hydrotreater.

The amount of molecular hydrogen supplied to the hydrotreater can be from about 300 SCF/B (standard cubic feet per barrel) (53 S m³/m³) to about 5000 SCF/B (890 S m³/m³), in which B refers to barrel of feed to the hydrotreater (e.g., tar stream plus utility fluid). For example, the amount of molecular hydrogen can be from 1000 SCF/B (178 S m³/m³) to 3000 SCF/B (534 S m3/m3). The amount of molecular hydrogen used to hydroprocess the condensate is less if the condensate contains higher amounts of C6+ olefin, for example, vinyl aromatics. Optionally, higher amounts of molecular hydrogen may be supplied, for example, when the condensate contains relatively higher amounts of sulfur.

Hydroprocessing catalysts can be utilized for hydroprocessing the condensate, such as those specified for use in resid and/or heavy oil hydroprocessing. Examples of suitable hydroprocessing catalysts include one or more of KF860 available from Albemarle Catalysts Company LP, Houston Tex.; Nebula® Catalyst, such as Nebula® 20, available from the same source; Centera® catalyst, available from Criterion Catalysts and Technologies, Houston Tex., such as one or more of DC-2618, DN-2630, DC-2635, and DN-3636; Ascent® Catalyst, available from the same source, such as one or more of DC-2532, DC-2534, and DN-3531; and FCC pre-treat catalyst, such as DN3651 and/or DN3551, available from the same source.

Other suitable hydroprocessing catalysts include those including (i) one or more bulk metals and/or (ii) one or more metals on a support. The metals can be in elemental form or in the form of a compound. In one or more embodiments, the hydroprocessing catalyst includes one or more metals from Groups 5 to 10 and/or 15 of the Periodic Table of the Elements (tabulated as the Periodic Chart of the Elements, The Merck Index, Merck & Co., Inc., 1996). Examples of such catalytic metals include, vanadium, chromium, molybdenum, tungsten, manganese, technetium, rhenium, iron, cobalt, nickel, ruthenium, palladium, rhodium, osmium, iridium, platinum, or mixtures thereof.

The metal may be incorporated into or deposited on a support including porous materials. The support can include one or more refractory oxides, porous carbon-based materials, zeolites, or combinations thereof suitable refractory oxides include, e.g., alumina, silica, silica-alumina, titanium oxide, zirconium oxide, magnesium oxide, and mixtures thereof. Suitable porous carbon-based materials include, activated carbon and/or porous graphite. Examples of zeolites include, e.g., Y-zeolites, beta zeolites, mordenite zeolites, ZSM-5 zeolites, and ferrierite zeolites. The support can be heat-treated at temperatures from about 750° F. to about 2200° F. (about 400° C. to about 1200° C.), such as from about 850° F. to about 1850° F. (about 450° C. to about 1000° C.), or from about 1100° F. to about 1650° F. (about 600° C. to about 900° C.), prior to impregnation, incorporation, or deposition with the metals. In at least one embodiment, the catalyst is heat treated after combining the support with one or more of the metals, heat treating of the catalyst and support together may take place at a temperature from about 300° F. to about 1380° F. (about 150° C. to about 750° C.), such as from about 400° F. to about 1360° F. (about 200° C. to about 740° C.), or from about 750° F. to about 1340° F. (about 400° C. to about 730° C.). The heat treatment may take place in the presence of hot air and/or oxygen-rich air at a temperature of about 750° F. (about 400° C.) or greater in order to remove volatile matter, and convert at least a portion of the metals to their corresponding metal oxide or metal sulfide.

The hydroprocessing is typically accomplished under conditions for carrying out one or more of hydrocracking (including selective hydrocracking), hydrogenation, hydrodesulfurization, hydrodenitrogenation, hydrodemetallation, hydrodearomatization, hydroisomerization, or hydrodewaxing of the condensate. Hydroprocessing of the condensate with treat gas and catalyst can occur in one or more hydrotreaters, the stages including one or more hydroprocessing vessels or zones downstream of the first separation system.

The condensate typically contacts the hydroprocessing catalyst in the vessel or zone, in the presence of the utility fluid and molecular hydrogen. Catalytic hydroprocessing conditions can include, e.g., exposing the condensate to a temperature from about 122° F. to about 932° F. (about 50° C. to about 500° C.), such as from about 392° F. to about 842° F. (about 200° C. to about 450° C.), from about 428° F. to about 806° F. (about 220° C. to about 430° C.), from about 572° F. to about 932° F. (about 300° C. to about 500° C.), from about 662° F. to about 806° F. (about 350° C. to about 430° C.), or from about 662° F. to about 788° F. (about 350° C. to about 420° C.) proximate to the molecular hydrogen and hydroprocessing catalyst. Liquid hourly space velocity (LHSV) of the condensate may be from about 0.1 h⁻¹ to about 30 h⁻¹, or about 0.4 h⁻¹ to about 25 h⁻¹, or about 0.5 h⁻¹ to about 20 h⁻¹. In some embodiments, LHSV is about 5 h⁻¹ or greater, or about 10 h⁻¹ or greater, or about 15 h⁻¹ or greater. Molecular hydrogen partial pressure during the hydroprocessing can be from about 0.1 MPa to about 8 MPa, or about 1 MPa to about 7 MPa, or about 2 MPa to about 6 MPa, or about 3 MPa to about 5 MPa. In some embodiments, the partial pressure of molecular hydrogen is about 7 MPa or less, about 6 MPa or less, about 5 MPa or less, about 4 MPa or less, about 3 MPa or less, about 2.5 MPa or less, or about 2 MPa or less. The hydroprocessing conditions can include, a pressure from about 1.5 mPA to about 13.5 mPA, or from about 2 mPA to about 12 mPA, or from about 2 mPA to about 10 mPA. The hydroprocessing conditions may further include a molecular hydrogen consumption rate of about 53 standard cubic meters/cubic meter (S m³/m³) to about 445 S m³/m³ (300 SCF/B to 2500 SCF/B, where the denominator represents barrels of the tar stream, e.g., barrels of SCT).

When hydroprocessed the hydrotreated condensate has improved properties compared to those of the condensate and may be suitable for use as a diesel fuel. For example, the hydrotreated condensate typically exhibits improved viscosity, solubility number, and insolubility number over the condensate and lower sulfur content than the condensate. The hydrotreated condensate may have a cetane number of about 40 to about 60, such as about 42 to about 58, about 44 to about 56, about 46 to about 54, or about 48 to about 52. Additionally, the hydrotreated condensate may be blended with other heavy hydrocarbon feeds or processes without further processing of the hydrotreated condensate prior to the blending.

The hydrotreated condensate has a sulfur concentration (also referred to as a “fifth sulfur concentration”) measured according to ASTM D5453 that can be about 0.5 wt %, about 1 wt %, about 2 wt %, about 3 wt %, about 5 wt %, about 6 wt %, about 8 wt %, or about 10 wt % to about 12 wt %, about 15 wt %, about 18 wt %, or about 20 wt % of the first sulfur concentration of the hydrocarbon feed. For example, the fifth sulfur concentration e can be about 0.5 wt % to about 20 wt %, about 1 wt % to about 20 wt %, about 1 wt % to about 18 wt %, about 1 wt % to about 15 wt %, about 1 wt % to about 12 wt %, about 1 wt % to about 10 wt %, about 1 wt % to about 8 wt %, about 1 wt % to about 5 wt %, about 1 wt % to about 3 wt %, about 5 wt % to about 20 wt %, about 5 wt % to about 15 wt %, about 5 wt % to about 12 wt %, about 5 wt % to about 10 wt %, about 5 wt % to about 8 wt %, about 10 wt % to about 20 wt %, about 10 wt % to about 18 wt %, about 10 wt % to about 15 wt %, or about 10 wt % to about 12 wt % of the first sulfur concentration of the hydrocarbon feed. The fifth sulfur concentration of the light hydrocarbon stream can be about 20 ppm or less, for example the fifth sulfur concentration may be from about 0.001 ppm to about 20 ppm, from about 0.01 ppm to about 18 ppm, from about 0.1 ppm to about 15 ppm, or from about 1 ppm to about 15 ppm.

### Third Separation System

The third separation system may include systems that are portions of other refinery processes, such as the fractionator portion of a coker unit, or the fluid catalytic cracking main column. Other suitable primary fractionators and associated equipment are described in U.S. Pat. No. 8,083,931 and U.S. Patent Publication No. 2016/0376511, which are incorporated by reference herein. Additional stages for removing heat (such as one or more transfer line heat exchangers) and removing tar (such as tar drums) can be located in or upstream of the third separation system, if desired.

### Apparatuses

Referring to FIG. 1, a hydrocarbon feed including light hydrocarbons may be fed through line 101 to reactor 103. Reactor 103 contains catalyst, and the product of the reaction, as a reactor effluent, is transferred via line 105 to heat exchanger 107. Heat exchanger 107 may be any suitable heat exchanger, including a shell-and-tube exchanger, spiral wound, airfin, double-pipe, a plate and frame, a plate and shell, a plate fin, a microchannel, or another indirect or direct contact heat exchanger. The cooled reactor effluent passes via line 109 to first separation system 111, which may be any suitable separation system that can separate heavy and light hydrocarbons, including a vapor-liquid separator, such as a flash pot or a knock-out drum. First separation system 111 separates a condensate which is removed via line 113, and a vapor stream, which is removed via line 115. The vapor stream is cooled in heat exchanger 117 and sent via line 119 to a second separation system 121. Second separation system 121 may be any suitable separation system for fractionating hydrocarbons, including a fractionator or distillation column. Second separation system 121 separates a hydrocarbon product stream via line 123 from a light hydrocarbon stream via line 125. The hydrocarbon product stream may be sent via line 123 for further processing including gasoline range refining processes.

The light hydrocarbon stream may be sent via line 125 for further processing or used in other refining processes.

One modification of the process shown in FIG. 1 is illustrated in FIG. 2, in which like reference numerals are used to indicate like components to those shown in FIG. 1. In particular, as shown in FIG. 2, the light hydrocarbon product stream may be recycled via line 227 to line 101 (or reactor 103 (not shown)) to provide additional hydrocarbon feed to reactor 103.

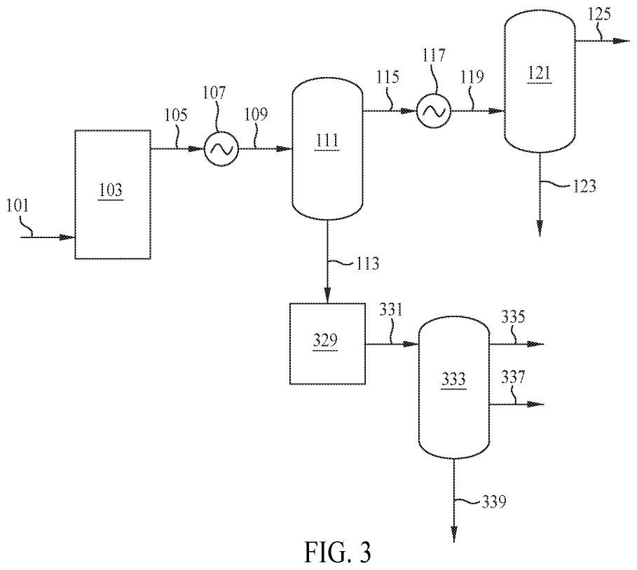

One modification of the process shown in FIG. 1 is illustrated in FIG. 3, in which like reference numerals are used to indicate like components to those shown in FIG. 1. In particular, as shown in FIG. 3, the condensate from first separation system 111 may be sent for further processing via line 113 to hydrotreater 329. Hydrotreater 329 produces a hydrotreated condensate sent via line 331 to third separation system 333. Third separation system 333 may include any suitable separation system for separating a distillate from gasoline and lighter components and may be part of a separate refinery system such as a coker fractionator or a main column of a fluid catalytic cracking system. In third separation system 333, the light hydrocarbons are removed via line 335, the gasoline range hydrocarbons are removed via line 337, and the distillate is removed via line 339.

### Other Embodiments of the Present Disclosure can Include:

Clause 1. A process for converting a hydrocarbon feedstock to a hydrocarbon product stream, the process including:

introducing the hydrocarbon feedstock to a reactor including a catalyst to form a reactor effluent having a temperature of from about 700° F. to about 1300° F., the catalyst including a crystalline microporous material;

cooling the reactor effluent to a temperature of from about 350° F. to about 550° F. to form a condensate and a vapor stream;

separating the condensate and vapor stream in a first separation system; and

introducing the vapor stream to a second separation system to form a hydrocarbon product stream and a light hydrocarbon stream.

Clause 2. The process of clause 1, where the hydrocarbon feedstock includes one or more C1-C6 aliphatic hydrocarbons.

Clause 3. The process of any of clauses 1 to 2, where the crystalline microporous material is a zeolite.

Clause 4. The process of any of clauses 1 to 3, where the reactor effluent includes sulfur and the condensate includes about 95 wt % or more of the sulfur of the reactor effluent.

Clause 5. The process of any of clauses 1 to 4, where about 1 wt % to about 30 wt % of the reactor effluent is condensed during cooling the reactor effluent.

Clause 6. The process of any of clauses 1 to 5, where the first separation system includes a vapor-liquid separator.

Clause 7. The process of any of clauses 1 to 6, further including hydrotreating the separated condensate.

Clause 8. The process of any of clauses 1 to 7, where the condensate has a T10 boiling point of 427° F. or more.

Clause 9. The process of any of clauses 1 to 8, where the hydrocarbon product stream has a T90 boiling point of 427° F. or less.

Clause 10. The process of any of clauses 1 to 9, where the light hydrocarbon stream has a T90 boiling point of about 120° F. or less.

Clause 11. The process of any of clauses 1 to 10, further including introducing the light hydrocarbon stream to the reactor.

Clause 12. The process of any of clauses 1 to 11, where the second separation system includes a fractionator.

Clause 13. The process of clause 12, where the fractionator is a fractional distillation column.

Clause 14. The process of clause 12, where the fractionator is a debutanizer.

Clause 15. The process of any of clauses 1 to 14, further including introducing the condensate to a third separation system to produce a distillate, where the distillate has a T10 boiling point of 427° F. or greater.

Clause 16. The process of clause 15, where the third separation system is a coker fractionator or an FCC main column.

Clause 17. A process for converting a hydrocarbon feedstock to a hydrocarbon product stream, the process including:

introducing the hydrocarbon feedstock to a reactor including a catalyst to form a reactor effluent having a temperature of from about 700° F. to about 1300° F., the catalyst including a crystalline microporous material;

cooling the reactor effluent to a temperature of from about 350° F. to about 550° F. to form a condensate and a vapor stream;

separating the condensate and vapor stream in a first separation system, where the condensate includes 50 wt % of distillate boiling components and where the condensate is about 3 wt % to about 30 wt % of the reactor effluent; and

introducing the vapor stream to a second separation system to form a hydrocarbon product stream and a light hydrocarbon stream.

Clause 18. The process of clause 17, where the vapor stream has a T90 boiling point of 427° F. or less.

Clause 19. An apparatus including:

a reactor;

a vapor-liquid separator coupled with the reactor;

a heat exchanger coupled with the reactor and the vapor-liquid separator; and

a separation system coupled with the vapor-liquid separator.

Clause 20. The apparatus of clause 19, where the separation system includes a fractional distillation column.

Clause 21. The apparatus of any of clauses 19 to 20, where the separation system includes a debutanizer.

Clause 22. The apparatus of any of clauses 19 to 21, further including a hydrotreatment apparatus coupled with the vapor-liquid separator.

Clause 23. The apparatus of any of clauses 19 to 22, further including a recycle line coupled with the separation system and the reactor.

### Examples

A hydrocarbon feed including 39 wt % (olefins) which were fed to the reactor at a WHSV of 1.5 h⁻¹, and 3.5 wt % light hydrocarbons, which were fed to the reactor at a WHSV of 4.0 h⁻¹. The reactor temperature stabilized at 699° F. (371° C.) and the reactor pressure was maintained at 304 psig. A ZSM-5 zeolite catalyst was used with a Si:Al ratio of 5:1 a porosity of 0.047 cc/g (micropore volume). The reactor effluent was cooled to 77° F. (25° C.) and a vapor stream and condensate separated in a vapor-liquid separation device. The composition of the vapor stream is shown in Table 1.

TABLE 1

| | Yield (Normalized | |
|---|---|---|
| Product | to 100 wt %) | |
| C2− | 0.15 | wt % |
| Propane | 0.22 | wt % |
| Propene | 0.28 | wt % |
| Isobutane | 0.32 | wt % |
| n-Butane | 1.16 | wt % |
| Butenes | 2.22 | wt % |
| Gasoline Range | 95.2 | wt % |
| Hydrocarbons (C5+) | | |
| Coke | 0.5 | wt % |

Overall, it has been found that various upgrading of light hydrocarbons produces a molecular weight distribution including heavy hydrocarbons, which may be removed in a flash separation vessel. Removal of the heavy hydrocarbons downstream of the reactor provides a substantial cost savings over previous methods which cooled and reheated the hydrocarbon product stream in order to effectuate separation of the hydrocarbons into desired product ranges. Furthermore, the removal of the heavy hydrocarbons produces a product more suitable for blending into fuel, such as gasoline and diesel. Additionally, the removal of the condensate removes a portion of the sulfur compounds in the reactor effluent and further decreases downstream sulfur processing costs of the gasoline range hydrocarbons and light hydrocarbons included in the vapor stream. Downstream processes may be designed to bring products within specifications of sulfur quantities. Removal of the various sulfur compounds may be accomplished by various downstream processes including hydrotreating of the condensate. The partitioning of sulfur compounds at various stages downstream of the light hydrocarbon upgrading reactor allows for design of processes and equipment that may produce gasoline, diesel, and light hydrocarbons having sufficiently low sulfur content to be sold or used in other processes.

The phrases, unless otherwise specified, “consists essentially of” and “consisting essentially of” do not exclude the presence of other steps, elements, or materials, whether or not, specifically mentioned in this specification, so long as such steps, elements, or materials, do not affect the basic and novel characteristics of this disclosure, additionally, they do not exclude impurities and variances normally associated with the elements and materials used.

For the sake of brevity, only certain ranges are explicitly disclosed herein. However, ranges from any lower limit may be combined with any upper limit to recite a range not explicitly recited, as well as, ranges from any lower limit may be combined with any other lower limit to recite a range not explicitly recited, in the same way, ranges from any upper limit may be combined with any other upper limit to recite a range not explicitly recited. Additionally, within a range includes every point or individual value between its end points even though not explicitly recited. Thus, every point or individual value may serve as its own lower or upper limit combined with any other point or individual value or any other lower or upper limit, to recite a range not explicitly recited.

All documents described herein are incorporated by reference herein, including any priority documents and/or testing procedures to the extent they are not inconsistent with this text. As is apparent from the foregoing general description and the specific embodiments, while forms of this disclosure have been illustrated and described, various modifications can be made without departing from the spirit and scope of this disclosure. Accordingly, it is not intended that this disclosure be limited thereby. Likewise, the term “comprising” is considered synonymous with the term “including” for purposes of United States law. Likewise whenever a composition, an element or a group of elements is preceded with the transitional phrase “comprising,” it is understood that we also contemplate the same composition or group of elements with transitional phrases “consisting essentially of,” “consisting of,” “selected from the group of consisting of,” or “is” preceding the recitation of the composition, element, or elements and vice versa. The processes or apparatuses disclosed herein suitably may be practiced in the absence of any element which is not specifically disclosed herein.

While this disclosure has been described with respect to a number of embodiments and examples, those skilled in the art, having benefit of this disclosure, will appreciate that other embodiments can be devised which do not depart from the scope and spirit of this disclosure.

The invention claimed is:

1. A process for converting a hydrocarbon feedstock to a hydrocarbon product stream, the process comprising:
introducing the hydrocarbon feedstock to a reactor comprising a catalyst to form a reactor effluent having a temperature of from about 700° F. to about 1300° F., the catalyst comprising a crystalline microporous material;
cooling the reactor effluent to a temperature of from about 350° F. to about 550° F. to form a condensate and a vapor stream;
separating the condensate and vapor stream in a first separation system; and
introducing the vapor stream to a second separation system to form a hydrocarbon product stream and a light hydrocarbon stream.

2. The process of claim 1, wherein the hydrocarbon feedstock comprises one or more C1-C6 aliphatic hydrocarbons.

3. The process of claim 1, wherein the crystalline microporous material is a zeolite.

4. The process of claim 1, wherein the reactor effluent comprises sulfur and the condensate comprises about 95 wt % or more of the sulfur of the reactor effluent.

5. The process of claim 4, wherein about 1 wt % to about 30 wt % of the reactor effluent is condensed during cooling the reactor effluent.

6. The process of claim 1, wherein the first separation system comprises a vapor-liquid separator.

7. The process of claim 1, further comprising hydrotreating the separated condensate.

8. The process of claim 1, wherein the condensate has a T10 boiling point of 427° F. or more.

9. The process of claim 8, wherein the hydrocarbon product stream has a T90 boiling point of 427° F. or less.

10. The process of claim 9, wherein the light hydrocarbon stream has a T90 boiling point of about 120° F. or less.

11. The process of claim 1, further comprising introducing the light hydrocarbon stream to the reactor.

12. The process of claim 1, wherein the second separation system comprises a fractionator.

13. The process of claim 12, wherein the fractionator is a fractional distillation column.

14. The process of claim 12, wherein the fractionator is a debutanizer.

15. The process of claim 1, further comprising introducing the condensate to a third separation system to produce a distillate, wherein the distillate has a T10 boiling point of 427° F. or greater.

16. The process of claim 1, wherein the third separation system is a coker fractionator or an FCC main column.

17. A process for converting a hydrocarbon feedstock to a hydrocarbon product stream, the process comprising:
introducing the hydrocarbon feedstock to a reactor comprising a catalyst to form a reactor effluent having a temperature of from about 700° F. to about 1300° F., the catalyst comprising a crystalline microporous material;
cooling the reactor effluent to a temperature of from about 350° F. to about 550° F. to form a condensate and a vapor stream;
separating the condensate and vapor stream in a first separation system, wherein the condensate comprises 50 wt % of distillate boiling components and wherein the condensate is about 3 wt % to about 30 wt % of the reactor effluent; and
introducing the vapor stream to a second separation system to form a hydrocarbon product stream and a light hydrocarbon stream.

18. The process of claim 17, wherein the vapor stream has a T90 boiling point of 427° F. or less.

19. An apparatus comprising:
a reactor;
a vapor-liquid separator coupled with the reactor;
a heat exchanger coupled with the reactor and the vapor-liquid separator; and
a separation system coupled with the vapor-liquid separator.

20. The apparatus of claim 19, further comprising a recycle line coupled with the separation system and the reactor.
